(19) United States
(12) Patent Application Publication
(10) Pub. No.: US 2019/0285830 A1
(43) Pub. Date: Sep. 19, 2019

(54) IMAGING DEVICE

(71) Applicant: NIDEC COPAL CORPORATION, Tokyo (JP)

(72) Inventor: Yuta NAKAMURA, Tokyo (JP)

(73) Assignee: NIDEC COPAL CORPORATION, Tokyo (JP)

(21) Appl. No.: 16/461,251

(22) PCT Filed: Nov. 17, 2017
(86) PCT No.: PCT/JP2017/041442

§ 371 Date: May 15, 2019

(30) Foreign Application Priority Data
Nov. 23, 2016 (JP) 2016-227359

(51) Int. Cl. G02B 7/02; G03B 35/08; H04N 13/239; H04N 5/225

(52) U.S. Cl. CPC G02B 7/023; G02B 7/021; G03B 35/08; H04N 2213/001; H04N 5/2254; H04N 5/2253; H04N 13/239

(57) ABSTRACT

An imaging device is having a substrate with a first imaging element and a second imaging element for sensing respective incident lights. A first lens frame for holding a first lens for guiding the incident light to the first imaging element and a second lens frame for holding a second lens for guiding the incident light to the second imaging element are included. A case is provided for holding the first lens frame and the second lens frame. In the state prior to securing, the first lens frame can be moved in the optical axial direction, and in a direction that is perpendicular to the optical axial direction, relative to the substrate. Also, in the state prior to securing, the second lens frame can be moved in the optical axial direction, and in a direction that is perpendicular to the optical axial direction, relative to the substrate.

### CROSS REFERENCE TO RELATED APPLICATIONS

This is a U.S. National Phase Application under 35 U.S.C. § 371 of International Patent Application No. PCT/JP2017/041442, filed Nov. 17, 2017, which claims priority of Japanese Patent Application No. 2016-227359, filed Nov. 23, 2016. The entire contents of which are hereby incorporated by reference.

### FIELD OF TECHNOLOGY

One aspect of the present invention relates to an imaging device.

### BACKGROUND

Recent years have seen a rise in popularity of so-called stereo cameras that are able to capture images of imaging subjects three-dimensionally by acquiring two imaging results having parallax through the provision of two sets of imaging element and lenses with prescribed spacing therebetween. In such stereo cameras there is the need to adjust appropriately the respective distances and angles between the imaging element and the lenses in each of the two sets, of imaging elements and lenses. Such stereo camera is disclosed in Japanese Unexamined Patent Application Publication 2015-56818.

In the conventional stereo camera, described above, the optical axis adjustment is carried out through a method such as capturing an image of a target chart while moving the substrates on which the imaging elements are installed, while holding the lenses stationary. Because of this, there has been the need to connect the imaging substrate and a tool to a substrate connector, to move them together, and thus operational efficiency has been poor. Moreover, because a plurality of substrates on which imaging elements are mounted are connected together by the connector, there has been a tendency for there to be noise in the electric signals, which has a negative effect on the imaging results.

### SUMMARY

The present invention adopts means such as the following in order to solve the problem described above. Note that while in the explanation below, reference symbols from the drawings are written in parentheses for ease in understanding the present invention, the individual structural elements of the present invention are not limited to those that are written, but rather should be interpreted broadly, in a range that could be understood technically by a person skilled in the art.

One means according to the present invention is:

An imaging device, having a substrate having a first imaging element and a second imaging element for sensing respective incident lights; a first lens frame for holding a first lens for guiding the incident light to the first imaging element; a second lens frame for holding a second lens for guiding the incident light to the second imaging element; and a case for holding the first lens frame and the second lens frame, wherein: in the state prior to securing, the first lens frame can be moved in the optical axial direction, and in a direction that is perpendicular to the optical axial direction, relative to the substrate; and

in the state prior to securing, the second lens frame can be moved in the optical axial direction, and in a direction that is perpendicular to the optical axial direction, relative to the substrate.

In the imaging device structured as described above, two imaging elements are provided, mounted on a common substrate, and the optical axes and the parallax can be adjusted by moving the lens frames in respect to stationary imaging elements. Because the positions of the lens frames are adjusted in relation to the imaging elements, adjustments to the optical axes and parallax can be achieved relatively easily. Moreover, because the imaging elements are mounted on a common substrate, this enables configurations that are robust to noise, which, by extension, makes it possible to achieve an improvement in the quality of the imaging results. In particular, mounting electronic components, and the like, on the common substrate enables configurations that are even more robust to noise, and thus is even more preferable.

Preferably the imaging device set forth above further has

a first attachment that can move in the plane that is perpendicular to the optical axial direction, in respect to the case, while supporting the first lens frame so as to enable movement thereof in the optical axial direction; and a second attachment that can move in the plane that is perpendicular to the optical axial direction, in respect to the case, while supporting the second lens frame so as to enable movement thereof in the optical axial direction.

The imaging device structured as described above enables a structure wherein the positions of the lens frames in relation to the imaging element can be adjusted easily, through the case and the lens frames being connected through an attachment.

In the imaging device set forth above, preferably:

the first attachment and the first lens frame are screwed together or connected using a cam; and

the second attachment and the second lens frame are screwed together or connected using a cam.

The imaging element structured as described above enables positional adjustment relatively easily in the optical axial direction through the ability to adjust the positions of the lenses, in the optical axial direction, in respect to the imaging elements through the amount to which the lens frames are screwed into the attachments.

Preferably the imaging device set forth above further comprises:

a first biasing member, disposed between the first lens frame and the case, for biasing the first lens frame in the optical axial rearward direction in for biasing the case in the optical axial forward direction; and

a second biasing member, disposed between the second lens frame and the case, for biasing the second lens frame in the optical axial rearward direction in for biasing the case in the optical axial forward direction.

The imaging device of the structure described above enables a structure wherein the positions of the case and the lens frames are stabilized, through the ability to bias the case and the lens frames away from each other through the biasing members.

In the imaging device set forth above, preferably:

the first biasing member and the second biasing member are respective compression springs.

The imaging device structured as described above enables structures wherein the positions of the case and the lens frames are stabilized through a relatively simple and inexpensive structure.

### BRIEF DESCRIPTIONS OF THE DRAWINGS

FIG. 1 is an external perspective diagram of the imaging device from the front optical axial direction.

FIG. 2 is an external perspective diagram of the imaging device from the back optical axial direction.

FIG. 3 is an assembly perspective diagram of the imaging device from the front optical axial direction.

FIG. 4 is an assembly perspective diagram of the imaging device from the back optical axial direction.

FIG. 5 is a cross-sectional diagram of the imaging device.

### DETAILED DESCRIPTION

The imaging device in the embodiment according to the present invention is a stereo camera wherein two imaging elements are mounted on a single substrate, and has, as a distinctive feature, the point that lens frames can be moved in respect to the imaging element.

An embodiment according to the present invention will be explained in detail below, referencing the drawings, following the structures below. However, the embodiment explained below is no more than an example of the present invention, and must not be interpreted as limiting the technical scope of the present invention. Note that in the various drawings, identical reference symbols are assigned to identical structural elements, and explanations thereof may be omitted.

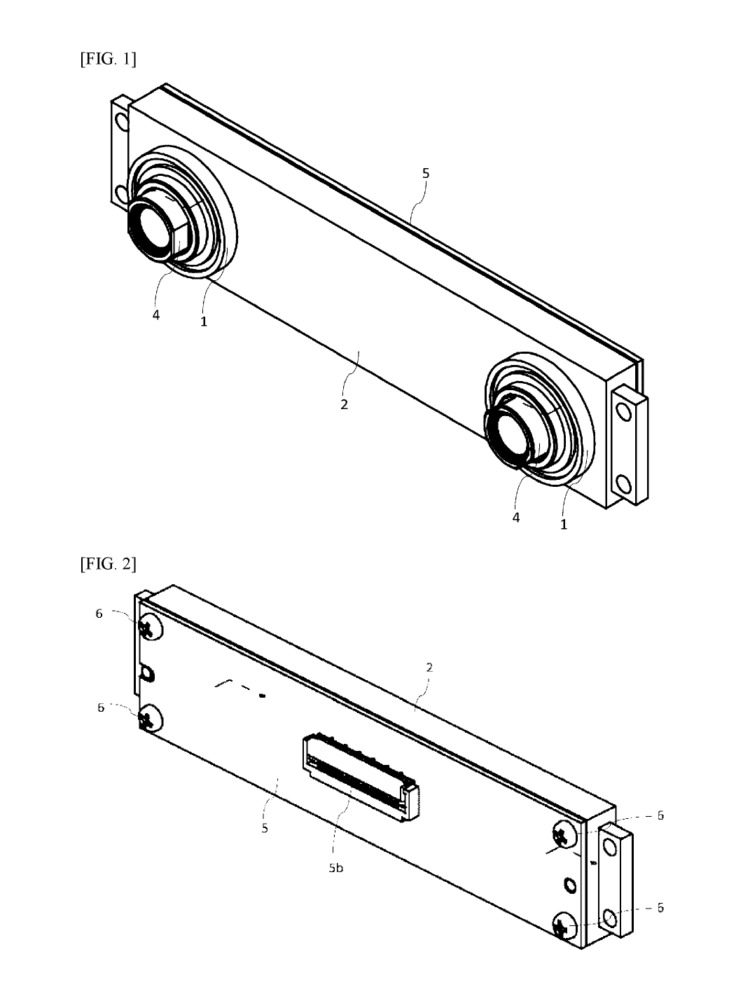

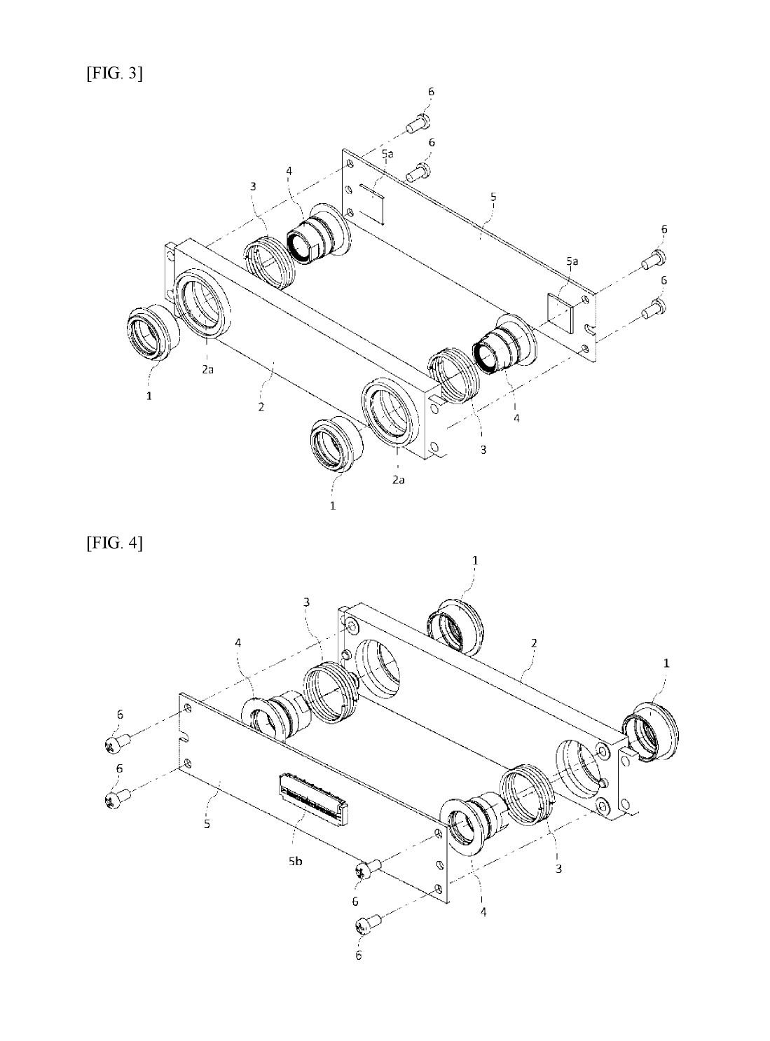

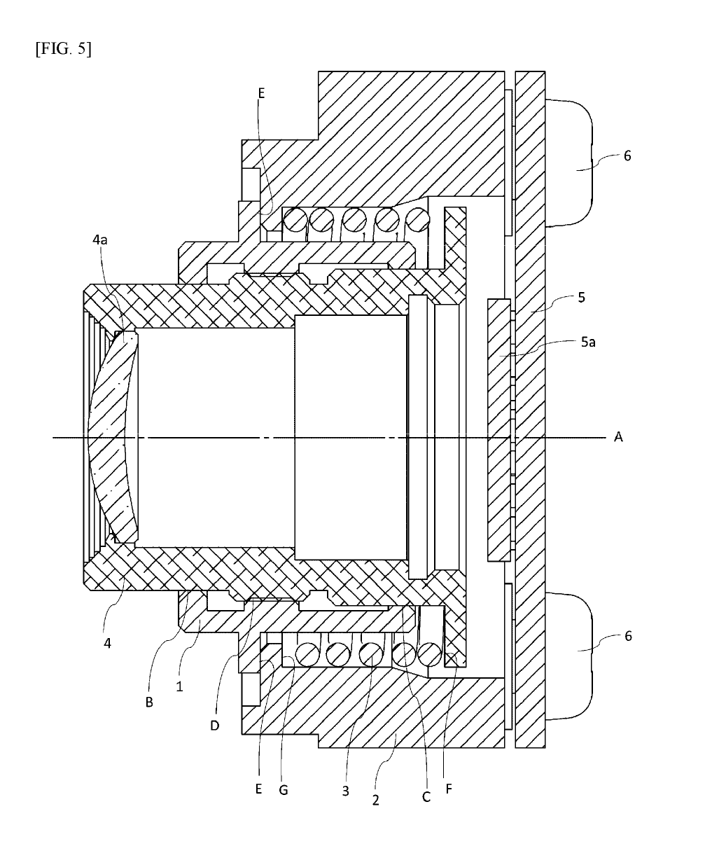

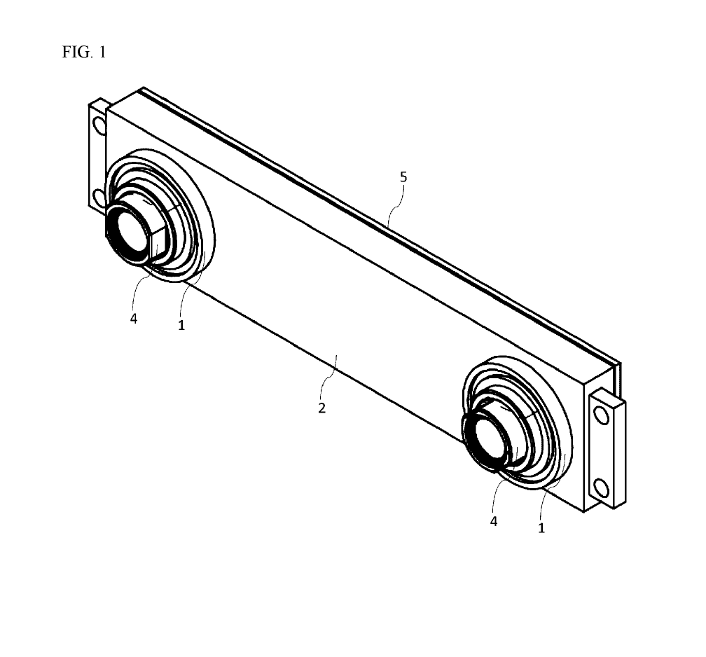

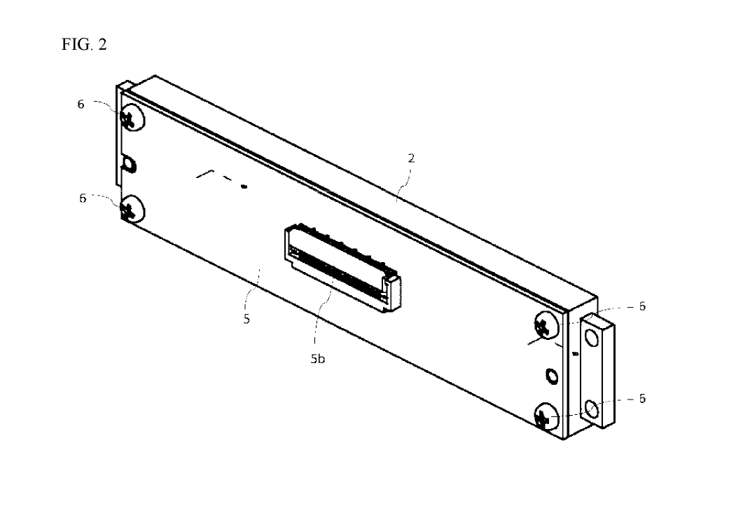

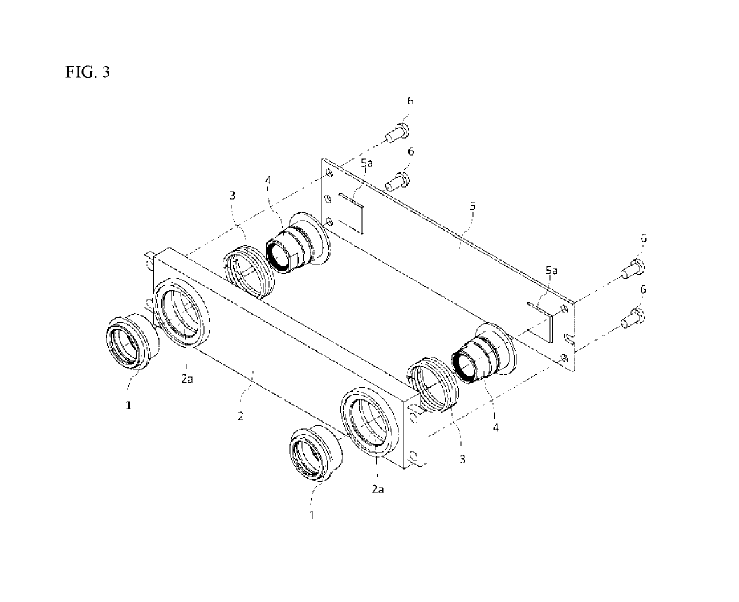

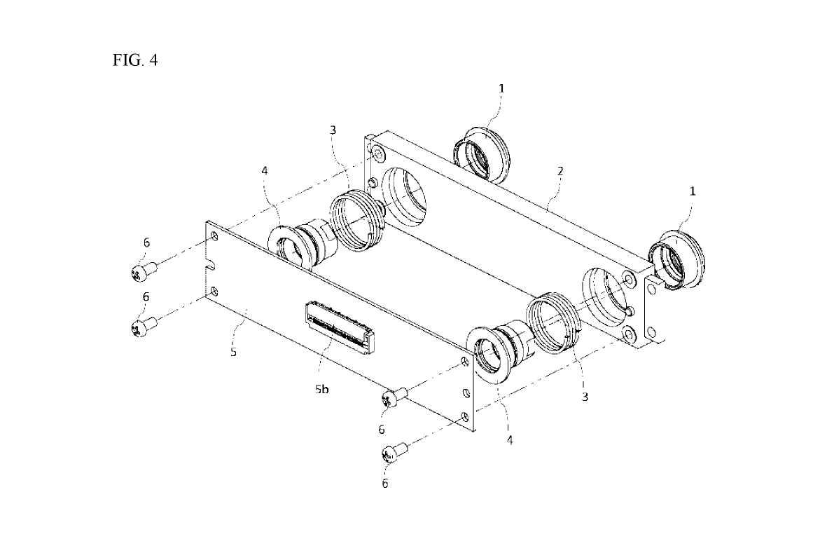

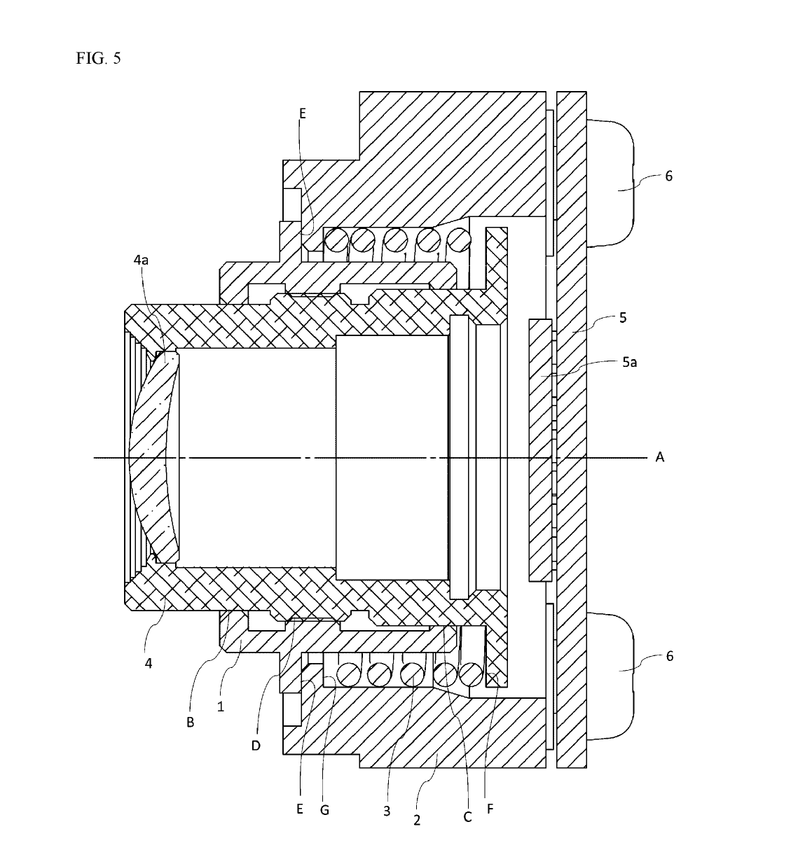

The structure of the imaging device according to the present invention will be explained in detail first. FIG. 1 is an external perspective diagram of an imaging device according the present embodiment viewed from the front optical axial direction (the photographic subject side). FIG. 2 is an external perspective diagram of an imaging device according the present embodiment viewed from the back optical axial direction (the imaging element side). FIG. 3 is an assembly perspective diagram of an imaging device according the present embodiment viewed from the front optical axial direction (the photographic subject side). FIG. 4 is an assembly perspective diagram of an imaging device according the present embodiment viewed from the back optical axial direction (the imaging element side). FIG. 5 is a cross-sectional diagram of the imaging device according to the present embodiment. In the optical axes A that have been set (referencing FIG. 5), the side whereon the imaging subject is located will be termed the “imaging subject side” or the “optical axial forward direction,” and the opposite side will be termed the “imaging element side” or “optical axial rearward direction.”

As depicted in FIG. 1 through FIG. 4, the imaging device according to the present embodiment is structured from attachments 1, a case 2, compression springs 3, lens frames 4, and a substrate 5. Imaging elements 5a and a connector 5b are installed on the substrate 5. The substrate 5 and the case 2 are connected securely through screws 6 that are inserted from the optical axial rearward direction. The imaging device in the present embodiment is a stereo camera able to acquire two imaging results, and thus is provided with two sets that each combines an attachment 1, a compression spring 3, a lens frame 4, and an imaging element 5a. These sets of the attachment 1, the compression spring 3, the lens frame 4, and the imaging element 5a are arranged at positions wherein there is a prescribed distance between the respective optical axes, making it possible to acquire two imaging results having parallax. Because the respective structures for the attachments 1, the compression springs 3, the lens frames 4, and the imaging elements 5a have identical structures in each of the two sets, in the explanation below the explanation will be, generally, for one of the structures, and the explanations will be omitted for the other structures.

The case 2 is for holding the lens frames 4, through the attachments 1, while covering at least a portion of the lens frames 4. The case 2 holds the substrate 5 through connection through screws 6. The case 2 has opening portions 2a through which the lens frames 4, the attachments 1, and the compression springs 3 are inserted. Opening portions 2a are formed for each of the two sets of lens frames 4, attachments 1, and compression springs 3. As depicted in the cross-sectional drawing in FIG. 5, the case 2 has an end face in the optical axial forward direction at location E, to contact the attachments 1 at this end face. Additionally, the case 2 has an end face in the optical axial rearward direction at location G, to contact the compression springs 3 at this end face.

The lens frames 4 are held by the case 2, through the attachments 1, and enclose and support a plurality of lenses. The periphery of at least a portion of the lens frame 4 is covered by the case 2. The lens frame 4 may contain spacers, filters, and the like, in addition to the plurality of lenses. Note that the number of lenses, and the like, enclosed within the lens frame 4 may be varied arbitrarily. As depicted in the cross-sectional drawing in FIG. 5, the lens frame 4 has an end face in the optical axial forward direction at location F, to contact a compression spring 3 at this end face.

The attachments 1 are disposed between the lens frames 4 and the case 2. As depicted in the cross-sectional drawing in FIG. 5, the attachment 1 contacts the outer peripheral surface of the lens frame 4 at the inner peripheral surface at locations B and C. The attachment 1 has a threaded hole in the inner peripheral surface at location D, to screw together with the outer peripheral surface threaded surface on the outer peripheral surface of the lens frame 4. The attachment 1 has an end face in the optical axial rearward direction at location E, and contacts the case 2 at this end face.

The compression springs 3 are disposed between the case 2 and the lens frames 4, to bias the case 2 and the lens frames 4 in the direction away from each other. Specifically, the compression spring 3 contacts the case 2 at location G in FIG. 5, to apply a biasing force to the case 2 toward the optical axial forward direction. Moreover, the compression spring 3 contacts the lens frame 4 at location F in FIG. 5, to apply a biasing force to the lens frame 4 toward the optical axial rearward direction. The compression spring 3 is an example of a “biasing member” in the present invention.

The substrate 5 is for installation of the two imaging elements 5a and the other electronic components, and is connected to the case 2 through screws 6. The connector 5b that is disposed rearward of the substrate 5 in the optical axial direction connects the imaging device electrically to an external device, and is used to transmit prescribed data, including imaging data of the imaging results, and to receive prescribed data, instructions, and the like. The substrate 5 is used for installation of electronic components, such as semiconductor devices, between the connector 5b and the two imaging elements 5a. The imaging elements 5a are photoelectric converting elements, such as CMOS or CCD, for converting incident light into an electric signal.

In the imaging device according to the present embodiment, the following is carried out when carrying out adjustments to the optical axes and adjustment of the parallax during assembly. As has already been explained, the lens frame 4 screws together with the attachment 1 at location D in FIG. 5, and thus the relative positioning of the lens frame 4 and the attachment 1 in the optical axial direction will vary depending on the amount to which they are screwed together. In this case, the positioning in the direction that is perpendicular to the optical axial direction essentially does not change. The attachments 1 and the case 2 are in contact at location E in FIG. 5, and, in the state prior to securing, the attachments 1 and the case 2 can be moved in the plane that is perpendicular to the optical axial direction. Because of this, when an attachment 1 is moved relative to the case 2, the relative positioning between the attachment 1 and the case 2 will change. The case 2 is connected to the substrate 5 through screws 6. Consequently, using the imaging element 5a of the substrate 5 as a reference, the attachment 1 is moved in the plane that is perpendicular to the optical axial direction, relative to the case 2, for which the location has been secured, and the lens frame 4 is moved in the optical axial direction. This makes it possible to move the lens frame 4 in all directions relative to the imaging element 5a. During assembly, the position of the lens contained within the lens frame 4 can be secured accurately in respect to the imaging element 5a through changing the location of the attachment 1 in respect to the case 2, and changing the amount by which the lens frame 4 is screwed together with the attachment 1. Once the location of the lens frame 4 (the lens) has been set accurately in respect to the imaging element 5a, locations D and E in FIG. 5 are secured through an adhesive agent, or the like, to secure the attachment 1 to the case 2.

Note that a compression spring 3 is disposed between the lens frame 4 and the case 2, to bias the case 2 in the optical axial forward direction, and to bias the lens frame 4 in the optical axial rearward direction, to thus bias the case 2 and the lens frame 4 in mutually opposing directions. This makes it possible to support the lens frame 4 in respect to the case 2 with stability, so as to not rattle or move.

Note that while, in the imaging device according to the present embodiment, the explanation used an example wherein the lens frame 4 and the attachment 1 were screwed together at location D, the connection between the lens frame 4 in the attachment 1 is not limited to screwing together. For example, the lens frame 4 in the attachment 1 may be secured using a cam, or may be fitted together or connected together through some other method. Moreover, the connecting location between the lens frame 4 and the attachment 1 is not limited to location D in FIG. 5.

Moreover, while in the imaging device according to the present embodiment the explanation was for an example wherein a compression spring 3 was used as the biasing member, another biasing member may be used instead of the compression spring 3. For example, a leaf spring or a member made of rubber, or the like, may be used as the biasing member instead of the compression spring 3.

Moreover, the contacting surfaces between the attachment 1, the case 2, and the lens frame 4 need not necessarily be in planes that are perfectly perpendicular to the optical axial direction, but rather shapes that have slopes, or the like, may be used instead.

The imaging device according to the present invention comprises: a substrate (5) that has a first imaging element and a second imaging element (5a) for sensing respective incident light; a first lens frame (4) for holding the a for directing incident light to the first imaging element; a second lens frame (4) for holding a lens for directing incident light to the second imaging element; and a case (2) for holding the first lens frame and the second lens frame. The first lens frame (4), in the state prior to being secured by the adhesive agent, or the like, can be moved in the optical axial direction and in the direction that is perpendicular to the optical axial direction, in respect to the substrate (5), and the second lens frame (4), in the state prior to being secured by the adhesive agent, or the like, can be moved in the optical axial direction and in the direction that is perpendicular to the optical axial direction, in respect to the substrate (5). In the imaging device structured as described above, two imaging elements (5a) are provided, mounted on a common substrate (5), and the optical axes and the parallax are adjusted by moving the lens frames (4) in respect to stationary imaging elements. Because the positions of the lens frames (4) are adjusted in relation to the imaging elements (5a), adjustments to the optical axes and parallax can be achieved relatively easily. Moreover, because the imaging elements (5a) are mounted on a common substrate (5), this enables configurations that are robust to noise, which, by extension, makes it possible to achieve an improvement in the quality of the imaging results. In particular, mounting electronic components, and the like, on the common substrate (5) enables configurations that are even more robust to noise, and thus is even more preferable.

The imaging device according to the present invention further comprises: a first attachment (1) that can be moved in the plane that is perpendicular to the optical axial direction, relative to the case (2), while supporting the first lens frame (4) so as to enable movement in the optical axial direction, and a second attachment (1) that can be moved in the plane that is perpendicular to the optical axial direction, relative to the case (2), while supporting the second lens frame (4) so as to enable movement in the optical axial direction. The imaging device that is structured in this way enables structuring so as to enable the positions of the lens frames (4) to be adjusted easily in respect to the imaging elements (5a), through connecting the case (2) and the lens frames (4) through the attachments (1).

Moreover, in the imaging device according to the present invention, the first attachment (1) is screwed together with, or secured through a cam to (D) the first lens frame (4), and the second attachment (1) is screwed together with, or secured through a cam to (D) the second lens frame (4). The imaging device structured in this way enables positioning adjustments in the optical axial direction to be carried out relatively easily, because the positions of the lenses in the optical axial direction can be adjusted in respect to the imaging elements (5a) through the amounts with which the lens frames (4) are screwed together with the attachments (1).

The imaging device according to the present invention further comprises a first biasing member (3) for biasing the first lens frame (4) in the optical axial rearward direction and for biasing the case (2) in the optical axial forward direction, disposed between the first lens frame (4) and the case (2), and a second biasing member (3) for biasing the second lens frame (4) in the optical axial rearward direction and for biasing the case (2) in the optical axial forward direction, disposed between the second lens frame (4) and the case (2). The imaging device of the structure described above enables a configuration wherein the positions of the case and the lens frames are stabilized, through the ability to bias the case (2) and the lens frames (4) away from each other through the biasing members.

Moreover, the imaging device according to the present invention enables configurations wherein the positions of the case (2) and the lens frames (4) are stabilized, through a relatively simple and inexpensive structure, because the first biasing member and the second biasing member are each compression springs.

An embodiment according to the present invention was explained in detail above. The explanation above is no more than an explanation of one form of embodiment, and the scope of the present invention is not limited to this form of embodiment, but rather is interpreted broadly, in a scope that can be understood by one skilled in the art.

The imaging device according to the present invention is well-suited for use in, for example, a stereo camera that is mounted in an automobile.

What is claimed is:

1. An imaging device, comprising:
a substrate comprising:
a first imaging element sensing respective incident light; and
a second imaging element sensing respective incident lights;
a first lens frame holding a first lens to configure to guiding the incident light to the first imaging element;
a second lens frame holding a second lens to configure to guiding the incident light to the second imaging element;
a case for holding the first lens frame and the second lens frame, wherein:
in the state prior to securing, the first lens frame can be moved in the optical axial direction, and in a direction that is perpendicular to the optical axial direction, relative to the substrate; and
in the state prior to securing, the second lens frame can be moved in the optical axial direction, and in a direction that is perpendicular to the optical axial direction, relative to the substrate.

2. The imaging device as set forth in claim 1, further comprising:
a first attachment that can move in the plane that is perpendicular to the optical axial direction, in respect to the case, while supporting the first lens frame so as to enable movement thereof in the optical axial direction; and
a second attachment that can move in the plane that is perpendicular to the optical axial direction, in respect to the case, while supporting the second lens frame so as to enable movement thereof in the optical axial direction.

3. The imaging device as set forth in claim 2, wherein:
the first attachment and the first lens frame are connected using a cam; and
the second attachment and the second lens frame are connected using a cam.

4. The imaging device as set forth in claim 2, further comprising:
a first biasing member, disposed between the first lens frame and the case, biasing the first lens frame in the optical axial rearward direction in biasing the case in the optical axial forward direction; and
a second biasing member, disposed between the second lens frame and the case, biasing the second lens frame in the optical axial rearward direction in biasing the case in the optical axial forward direction.

5. The imaging device as set forth in claim 4, wherein:
the first biasing member and the second biasing member are respective compression springs.
